(19) United States
(12) Patent Application Publication
(10) Pub. No.: US 2010/0096580 A1
(43) Pub. Date: Apr. 22, 2010

(54) METHOD AND DEVICE FOR PRODUCING A MOLDED PART AND MOLDED PART AS HEAT INSULATING AND/OR SOUND ABSORBING ELEMENT

(75) Inventor: Axel Daschkeit, Bergkamen (DE)

Correspondence Address: HARNESS, DICKEY & PIERCE, P.L.C., P.O. BOX 828, BLOOMFIELD HILLS, MI, 48303, US

(73) Assignee: DEUTSCHE ROCKWOOL MINERALWOLL GMBH & CO. OHG, Gladbeck (DE)

(21) Appl. No.: 12/527,987

(22) PCT Filed: Feb. 9, 2008
(86) PCT No.: PCT/EP08/00999

§ 371 Date: Nov. 4, 2009

(30) Foreign Application Priority Data
Feb. 23, 2007 (DE) 10 2007 009 337.5
Aug. 2, 2007 (DE) 10 2007 036 346.1

(51) Int. Cl. B60R 13/08; B29C 59/02; B28B 3/10

(52) U.S. Cl. 252/62; 264/320; 425/517

(57) ABSTRACT

The invention relates to a method and to a device for producing a molded part that is preferably configured as a heat insulating and/or sound absorbing element, particularly a press-molded part made of mineral fibers, for example stone and/or glass fibers. The invention further relates to a molded part as a heat insulating and/or sound absorbing element, particularly as a lining part in vehicle construction, produced using a generic method, made of mineral fibers, particularly stone and/or glass fibers. In order to further develop a method, a device, and a molded part having high flexibility with respect to the molded parts to be produced and/or configure the molded part in a simple and diverse variety, according to the invention the mineral fibers are accumulated as flakes and/or granules, with or without bindings agents, having a predetermined bulk density and/or predetermined basis weight and/or predetermined binding agent percentages, filled in a mold, and subsequently pressed to form a molded part, particularly a press-molded part.

The invention pertains to a method and a device for producing a moulded part that is preferably realized in the form of a heat and/or sound insulating element, particularly a compression-moulded part of mineral fibers such as, for example, rock wool and/or glass fibers. The invention furthermore pertains to a moulded part in the form of a heat and/or sound insulating element, particularly as a lining part used in automobile construction, which is produced with an initially cited method and consists of mineral fibers, particularly rock wool and/or glass fibers.

Different methods for producing a moulded part that is preferably realized in the form of a heat and/or sound insulating element, particularly a compression-moulded part, are known from the state of the art. For example, DE 42 13 388 A1 discloses a method for producing a sound or heat insulating component such as, for example, a panel, a shell, a moulded part or the like used for noise control and sound insulation purposes. In this known method, fibers or yarns are drawn from a rock melt, particularly a basalt rock melt, with the aid of nozzles, wherein said yarns or fibers are cooled and hardened with the aid of spray water and gathered into a matted formed fabric or a mat on a moving surface. It is proposed that the fibers or yarns are treated with a phenol-free binder that is dissolved in water, wherein said binder by itself is not toxic and also does not produce any toxic vapors or gases when it is heated. The matted formed fabrics or mats produced with the fibers or yarns are subsequently compressed into moulded parts or panels such as, for example, smooth or corrugated panels or structural components with densities in the range between 120 kg/m³ and 300 kg/m³. As long as these moulded parts or panels have a sufficient density, these elements are robust and dimensionally stable. The dimensional stability can also be influenced by choosing the substrate accordingly.

In this known method, it proved disadvantageous that the production of moulded parts, particularly compression-moulded parts of different designs, makes it necessary to store different base materials, namely different matted formed fabrics and mats. Furthermore, these base materials can only be insignificantly influenced with respect to their composition of mineral fibers and binders such that increased storage expenditures for the base materials are also required in this regard.

Based on this state of the art, the invention aims to additionally develop an initially cited method and an initially cited device, as well as an initially cited moulded part in the form of a heat and/or sound insulating element, in such a way that a high flexibility with respect to the moulded parts to be produced can be achieved with the initially cited method and an initially cited device, wherein the objective with respect to the moulded part consists of realizing said moulded part easier and in a diverse variety.

According to a first embodiment of the inventive method, this objective is attained in that the mineral fibers are agglomerated in the form of flocks and/or granulates, filled into a mould with or without binders and with predetermined bulk density and/or predetermined mass per unit area and/or predetermined binder proportions and subsequently compressed into a moulded part, particularly a compression-moulded part.

According to a second embodiment of the inventive method, the aforementioned objective is attained in that the mineral fibers are deposited on a conveying element that becomes a component of the moulded part, wherein a section of the conveying element with mineral fibers arranged thereon is cut off, particularly during or after the compression process.

With respect to the inventive moulded part, the aforementioned objective is attained in that the moulded part consists of mineral fibers that are agglomerated in the form of flocks and/or granulates, arranged in a mould and/or on a substrate with or without binders and with predetermined bulk density and/or predetermined mass per unit area and/or predetermined binder proportion and connected to one another under pressure, wherein the flocks and/or granulates are connected to the substrate or the mould.

Accordingly, the invention proposes that, contrary to the above-described state of the art, the moulded parts are not produced from formed mineral fiber fabrics or mineral fiber mats, but rather from mineral fibers agglomerated into flocks and/or granulates. In this case, individual mineral fibers are processed in such a way that they are subsequently agglomerated into flocks that, however, can be readily handled with respect to their consistency and, in particular, are arranged in a mould or on a substrate in dependence on a desired mass per unit area or a desired bulk density. This method provides the particular advantage that the manufacturer of such moulded parts or compression-moulded parts merely needs to be provided with two components. The two components required by the manufacturer are the flocks and/or granulates of agglomerated mineral fibers and the binder for binding the mineral fibers of the flocks and/or granulates. For this purpose, the flocks and/or granulates are filled into a mould and subsequently compressed. After the compression process, the moulded part has its final shape and is suitable for additional processing, namely without requiring another processing step such as, for example, cutting the moulded part to size or hardening the binder. According to the invention, it is also possible to provide a prepared mixture of mineral fibers and binders that is filled into the mould as one component.

Accordingly, the invention disassociates itself, in particular, from the notion that the intermediate product for the production of moulded parts or compression-moulded parts of mineral fibers needs to be present in mat-shaped or panel-shaped form. The flocks or granulates can be easily handled, particularly metered, and compressed into moulded parts with different binders depending on the intended use.

According to another characteristic of the invention, it is proposed that the flocks and/or granulates are produced from mat-shaped and/or panel-shaped formed fabrics with or without, in particular, hardened binder. Accordingly, the production of the fibers for the flocks and/or granulates can be carried out during the course of a conventional production method to the effect that a mineral melt is produced in a melting assembly and fed to a defibrator, in which the melt is defibrated into micro-fine fibers, the mineral fibers are wetted with binding and/or impregnating agents and subsequently deposited on a conveyor belt in the form of a formed fabric layer. This formed fabric layer is then disintegrated in such a way that flocks and/or granulates are produced that respectively consists of a multitude of mineral fibers. It is furthermore possible to utilize residual materials accumulated during the production of conventional mineral fiber insulations, for example during edge trimming, for producing the flocks and/or granulates of mineral fibers. In addition, it is possible to disintegrate mineral fiber insulations dismantled during the course of a recycling project and to subsequently process the mineral fiber insulations into flocks and/or granulates that serve as base material for the production of the moulded parts, particularly the compression-moulded parts. The flocks and/or granulates naturally can also be produced from a mixture of recycling material, production-related residual materials and/or produced fiber material.

According to another characteristic of the invention, it is proposed that the flocks and/or granulates are produced from agglomerated mineral fibers that are wetted with binder(s). Mineral fibers that are connected mechanically, for example during the course of needling or fiber mingling processes, represent an alternative to flocks and/or granulates. It proved sensible to maintain a low binder content. A reduction of the binder contents makes it possible to ensure a low flammability of these materials and therefore to comply with an adequate fire classification.

It is preferred to add the binder to the flocks and/or granulates before they are filled into the mould. This pertains to an additional binder that ensures the bond between the individual flocks and/or granulates in the mould. According to an alternative variation, the binder is added to the flocks and/or granulates while and/or after they are filled into the mould. Consequently, this variation proposes that the binder is filled into the mould simultaneously with the flocks and/or granulates. This causes the flocks and/or granulates to be adequately mixed with the binder. The binder may be additionally or alternatively added after the flocks and/or granulates are filled into the mould. If a liquid binder is used, this binder is also distributed in an essentially uniform fashion between the flocks and/or granulates in this production step. On the other hand, this also makes it possible to realize a layer structure, in which the binder is arranged on the surface of the flocks and/or granulates and therefore forms a seal or coating, respectively.

The flocks and/or granulates are preferably processed with a maximum size that passes through a mesh up to 100 mm, particularly up to 35 mm, preferably up to 12.5 mm, wherein the mesh respectively begins at 0.1 mm. It furthermore proved advantageous to fill the flocks and/or granulates into the mould with a bulk density of 20 to 1000 kg/m³, particularly 20 to 600 kg/m³, preferably 50 to 300 kg/m³, in order to produce moulded parts or compression-moulded parts that have a sufficient stability, particularly a sufficient flexural strength.

The binder is preferably hardened by means of pressure and/or heat during the compression process. Depending on the binder, the pressure that is usually generated in the production of corresponding moulded parts may suffice for achieving sufficient temperature conditions in the mould so as to harden the binder. In order to accelerate the hardening process, it proved advantageous to increase the temperature in the compression tool during the compression process. The hardening process can preferably be carried out and/or accelerated with steam.

Inorganic and/or organic binders, particularly of renewable raw materials such as, for example, starch and/or glucose, proved advantageous as binders such that these binders are used during the course of the inventive method.

According to another characteristic of the invention, it is proposed that the flocks and/or granulates are agglomerated into larger elements, particularly into flock and/or granulate strips, or into moulded parts that preferably are highly compressed such as filler cushions, strips, webs, profiles or the like before they are filled into the mould. Elements of this type may, for example, be arranged on the outside in the mould while the flocks and/or granulates are arranged between these elements. These elements make it possible to adjust a pressure distribution within the mould during the compression process.

The flocks and/or granulates can be produced from fibers of different base materials. It would be possible, for example, to produce mixtures of mineral fibers such as, for example, glass fibers and rock wool, as well as mixtures of mineral fibers and other fibers such as, for example, wood fibers, cotton fibers, plant fibers, animal hair or the like and/or synthetic fibers. The latter-mentioned synthetic fibers may very well serve as binders in this case as long as they have, for example, thermoplastic properties such that they develop an adhesive effect during the course of their melting.

The flocks and/or granulates preferably serve for producing moulded parts with a mass per unit area between 200 and 7500 g/m², particularly between 500 and 5000 g/m², preferably between 500 and 4000 g/m². In order to carry out the method, it is proposed that the flocks and/or granulates are stored in a reservoir, withdrawn from the reservoir in the required quantity and fed to at least one mould. In this respect, it proved advantageous to transport the flocks and/or granulates pneumatically. During the course of the transport, the flocks and/or granulates are preferably loosened and/or homogenized along the transport path. A corresponding loosening and/or homogenizing may additionally or alternatively take place in the reservoir.

The binder is admixed to the flocks and/or granulates in liquid, powdery and/or fibrous form, wherein the admixing of the binder may take place—as mentioned above—in or immediately before the mould and/or immediately after the withdrawal from the reservoir. In this respect, it proved advantageous to feed at least one liquid binder to the flocks and/or granulates, particularly in atomized form, before and/or while they are filled into the mould.

The flocks and/or granulates are preferably deposited on a carrier material after the admixing of the binder. The flocks and/or granulates can be compressed into a moulded part together with the carrier material. If the moulded part is produced in a mould, it proved advantageous to remove the mould after the hardening of the binder. A formed glass fiber fabric, a formed carbon fiber fabric, a plastic or metal foil and/or a combination of these materials proved particularly advantageous as carrier material. Furthermore, so-called SMCs (sheet moulding compounds) are particularly suitable as carrier material. Alternatively, it would be possible that the mould forms a component of the moulded part. In addition, the moulded part can be arranged on a carrier material in the form of an intermediate product after the removal of the mould, wherein the moulded part is subsequently connected to this carrier material by means of a supplementary binder.

According to another characteristic of the invention, it is proposed that a moulded body is preformed in a blank mould, subsequently removed and transported to a compression process. This embodiment of the invention has the advantage that the moulded body can be preformed of a relatively loose arrangement of flocks and/or granulates. In this method, the binder usually is already slightly hardened by the ambient temperature such that the shape of the moulded body produced in the blank mould can also be preserved after the removal therefrom. However, it would also be possible, in principle, to pre-harden the binder before the compression process, for example, in order to shorten the hardening time and therefore the compression times.

In an above-described method, it also proved advantageous to realize the moulded parts with highly compressed edge regions and/or pinch edges.

An alternative variation of the inventive method consists of a cyclic or quasi-continuous method for producing moulded parts or compression-moulded parts that can be used, in particular, in the automobile industry. Such compression-moulded parts for the automobile industry are usually laminated with a formed fabric or the like on at least one side. Due to the utilization of mineral fibers, particularly in the form of flocks and/or granulates, these moulded parts can be produced with different masses per unit area and/or laminations.

According to the second alternative variation of the inventive method, it is proposed that mineral fibers, particularly in the form of a granulate, are withdrawn from a reservoir and deposited on a downstream conveying device. The mineral fibers are preferably sprayed with a binding and/or impregnating agent with the aid of laterally arranged nozzles or the like shortly before they are deposited on the conveying device, wherein the binding and/or impregnating agents can be realized differently. The binding and/or impregnating agents can be admixed in the form of a liquid or granules.

The conveying device features a conveying element, on which the mineral fibers are deposited. This conveying element becomes a component of the moulded part to be produced, wherein a section of the conveying element with the mineral fibers arranged thereon is cut off, particularly during or after the compression process. For example, a formed carbon fiber fabric that serves as lamination in the moulded part may be considered as conveying element. The conveying device furthermore features a plurality of rollers that are aligned parallel to one another and over which the conveying element is transported. These rollers preferably have a surface with a high coefficient of friction so as to ensure an unproblematic transport of the conveying element, namely even if the mineral fiber mass is arranged thereon. Projections that positively engage into the conveying element, particularly spikes, may be additionally or alternatively provided. These spikes are preferably arranged on the outside of the rollers such that they engage into the lateral edge region of the conveying element. In the region of the compression device, the conveying element is guided by sprockets that are arranged, in particular, to both sides of the compression device.

The conveying element is unwound from a supply roll, wherein a continuous or a cyclic unwinding of the conveying element from the supply roll may be considered. The manner, in which the conveying element is unwound from the supply roll, primarily depends on the mode of operation of a compression device arranged downstream of the conveying device.

The conveying element with mineral fibers thusly arranged thereon is then transported to a compression device that exerts, in particular, a high pressure upon the conveying element and the mineral fibers such that this device can be referred to as a pressing device. The compression device features a die that is realized in the form of a female mould for shaping the moulded part and a counterpressure plate. The compression device may also feature several dies with female moulds. This variation is particularly sensible if relatively small moulded parts are produced.

When producing three-dimensional moulded parts, the pressing device consists of contradirectional dies, the surfaces of which feature the shaping female moulds. When producing smaller three-dimensional moulded parts, it may be advantageous to arrange several of these die systems in a pressing device.

The desired moulded part is compressed in the compression device and the binder that, if applicable, is contained in or admixed to the mineral fibers simultaneously is thermally hardened. It would also be possible to activate the binder, for example, in the form of granules by means of hot air in the compression device and to subsequently harden the binder.

The die with the female mould or the female moulds preferably has a smaller width than the conveying element such that the spiked rollers engage into the conveying element outside of the die and the conveying element is pushed and/or pulled through the dies due to the rotational movement of at least one spiked roller in this embodiment. When using a discontinuously operating compression device, it is proposed that the advance of the conveying means by means of the rollers is controlled in dependence on the pressing process such that the rollers are not driven during the pressing process.

The elasticity of the conveying element ensures that the moulded body also remains guided by the spikes of the rollers that engage into the conveying element during the pressing process such that it can be guided out of the compression device after the pressing process.

Downstream of the compression device, a strip of interlinked compression-moulded parts is laterally guided by the spikes of the rollers and transported to a cutting and/or trimming system. In this cutting and/or trimming system, the edge regions of the separated moulded parts that extend in the longitudinal direction are trimmed and the interlinked moulded parts are separated from one another transverse to the longitudinal direction of the strip. If the strip comprises several moulded parts that are arranged adjacent to one another transverse to the longitudinal direction, additional cutting devices are provided that make it possible to produce a cut in the transport direction or in the longitudinal direction of the strip, respectively. For example, circular knives and band knives proved particularly suitable for this purpose.

In a device for carrying out this method, it is advantageous that these cutting devices can be adjusted relative to the strip that consists of the conveying element with the mineral fibers arranged thereon and was compressed in the compression device.

According to another characteristic of the invention, it is proposed that the mineral fibers in the form of a granulate and/or flocks are withdrawn from the reservoir and deposited on the conveying element in dependence on the cycle of the compression device such that material fiber piles are deposited on the conveying element at a distance from one another. This design saves fiber material and furthermore simplifies the cutting of the conveying element between adjacent moulded parts. The service life of the cutting devices used for this purpose is significantly extended due to the fact that only one or two formed fabric layers need to be cut, but no agglomerated mineral fibers.

According to another characteristic of the invention, it is proposed that a lamination is arranged on the mineral fibers placed on the conveying element. The lamination is preferably transported to the compression device together with the conveying element and the mineral fibers and connected to the conveying element in the compression device. In the edge region, for example, the connection can be produced by means of binders. However, a connection can also be produced by activating and hardening the binder contained in the mineral fiber mass during the compression process. In this case, the conveying element and the lamination bond with the binder contained in the mineral fiber pile such that a moulded part with laminations on both sides is obtained after the compression process.

As an alternative to the above-described variations, a continuous process can be realized if the compression device features at least two contradirectional compression rollers, between which at least the conveying element and the mineral fibers and optionally also the lamination are guided. At least one female mould is arranged in at least one circumferential surface of a compression roller. When producing smaller moulded parts, several female moulds may be arranged in at least one compression roller.

It furthermore proved advantageous to respectively heat the compression rollers or the dies in the compression device so as to provide supplementary thermal energy for accelerating the hardening of the binder. The compression rollers or the dies may be additionally or alternatively perforated, particularly micro-perforated, such that hot air can be blown through the compression rollers or the dies in order to shorten the hardening time of the binder. This is possible, in particular, due to the utilization of mineral wool because this minimal wool is open to diffusion.

In other respects, the above-described advantages of the inventive method also apply to an inventive moulded part.

Other characteristics and advantages of the invention are disclosed in the following description of the drawings, in which an inventive moulded body and segments of the inventive method are respectively illustrated. In these drawings:

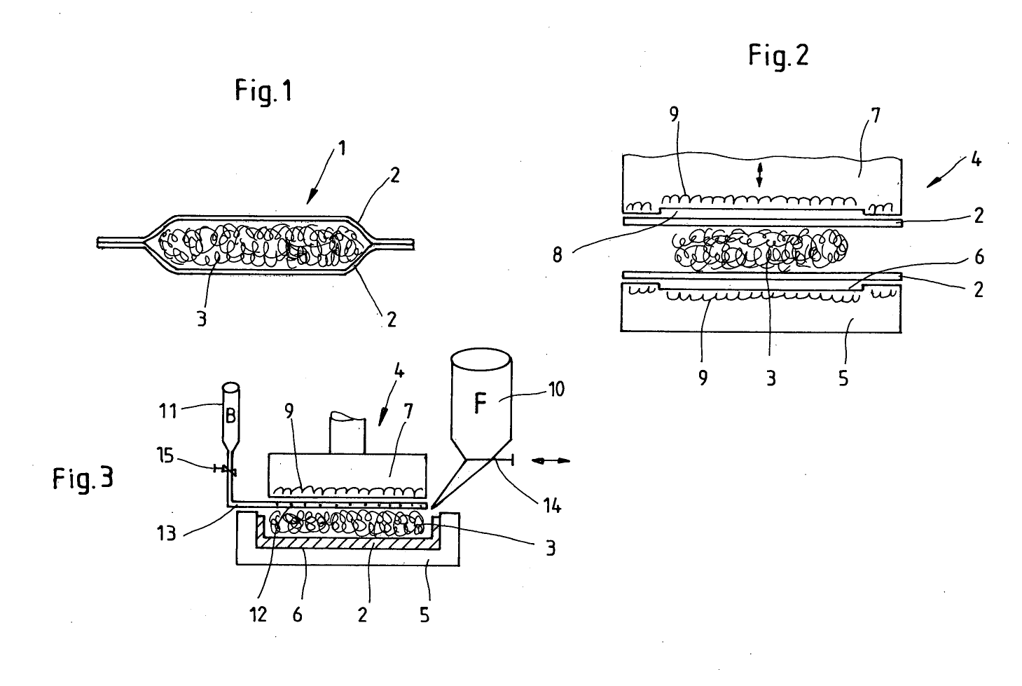

FIG. 1 shows a moulded body in the form of a sectioned side view;

FIG. 2 shows a compression tool for carrying out a method for producing a compression-moulded part of mineral fibers;

FIG. 3 shows a compression tool and a reservoir for carrying out the method according to FIG. 2, and

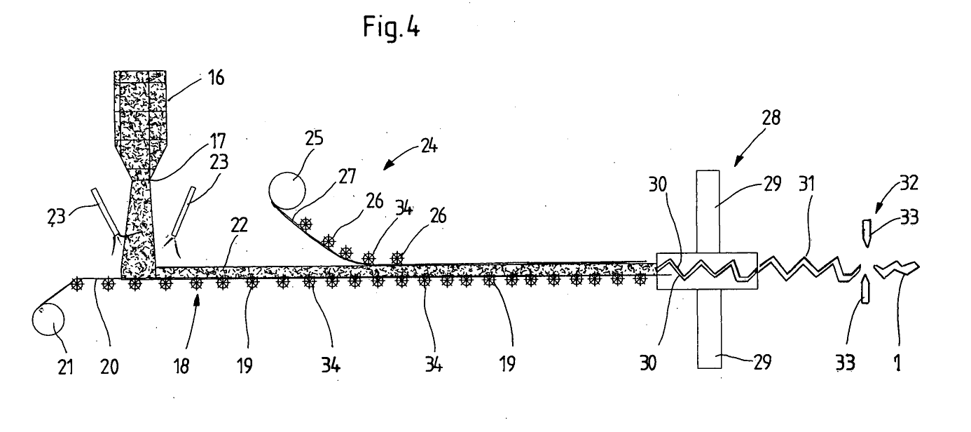

FIG. 4 shows a schematic representation of a device for producing a moulded body.

A moulded part 1 illustrated in FIG. 1 consists of two congruently arranged carrier materials 2, for example, of a formed carbon fiber fabric and a moulded body 3 of mineral fibers that are agglomerated into flocks and/or granulates and bound with binders. The carrier materials 2 are continuously connected to one another around the moulded body 3 by means of a binder.

FIG. 2 shows a first embodiment of a pressing device for producing a moulded part 1 according to FIG. 1. The pressing device 4 consists of a lower die 5 with a mould 6 and an upper die 7 that features another mould 8. The mould 6, as well as the mould 8, is respectively realized in the form of a recess in the lower die 5 and the upper die 7.

The lower die 7 and the upper die 7 feature heating elements 9 in the region of the mould 6 and the mould 8 in order to heat the upper die 7 and the lower die 5 in the region of the moulds 6 and 8 and to thusly harden a binder between the fibers of the moulded body 3.

The upper die 7 can be moved toward and away from the lower die 5 in accordance with the double arrow in FIG. 2.

FIG. 3 shows an alternative compression device 4 with a reservoir 10 for fiber material and a reservoir 11 for binder.

Mineral fibers are pneumatically transported from the reservoir 10 into the mould 6 of the lower die 5, namely onto a substrate in the form of a carrier material 2, as flocks and/or granulates. The binder is simultaneously withdrawn from the reservoir 11 and fed to a supply line 13 that features a plurality of nozzles 12 and extends over nearly the entire length of the mould 6 of the lower die. The binder is sprayed onto the flocks and/or granulates by the nozzles 12 until a desired bulk density of the flocks and/or granulates, as well as a desired binder proportion, is adjusted in the mould 7.

Subsequently, the supply line 13 is horizontally pivoted by 90° from the position illustrated in FIG. 3 such that the upper die 7 can be displaced into the lower die. The upper die 7 compresses the fiber material in order to form the moulded body 3, wherein the temperature required for thermally hardening the binder is simultaneously generated by the heating element 9. The binder furthermore connects the moulded body 3 to the carrier material 2 such that an integral moulded part 1 is obtained.

The supply of flocks and granulates from the reservoir 10 is controlled by means of a slide 14 at the outlet of the reservoir 10 while the supply of the binder from the reservoir 11 can be controlled by means of a valve 15.

The pressing devices illustrated in FIGS. 2 and 3 are used in methods for producing a moulded part that serves as a sound insulating element, wherein the moulded part 1 of mineral fibers is agglomerated into flocks and/or granulates, filled into a mould 6 with a binder and with a predetermined bulk density and predetermined binder proportion and subsequently compressed into a moulded part (1). The flocks and/or granulates are produced of mat-shaped or panel-shaped fibrous formed fabrics in these methods and stored in a reservoir 10. The flocks and/or granulates are applied onto a substrate in the form of a carrier material 2 in the mould 6 together with the binder from the reservoir 11 and subsequently compressed into a moulded part 1. In this method, the flocks and/or granulates have a size that passes through a mesh of 12 to 12.5 mm.

FIG. 4 schematically shows a device for producing a moulded part 1. The device consists of a reservoir 16, in which mineral fibers in the form of granulates and/or flocks are stored. The reservoir 16 features an outlet 17, through which the mineral fibers can be continuously or cyclically withdrawn from the reservoir 16. A conveying device 18 arranged downstream of the reservoir 16 consists of a plurality of parallel rollers 19 that serve for transporting a conveying element 20. The conveying element 20 consists of a fibrous formed fabric that is stored on a supply roll 21 arranged upstream of the conveying device 18 and unwound therefrom.

The mineral fibers are deposited onto the conveying element in the form of a fiber strip 22 of uniform thickness. Before the mineral fibers are deposited on the conveying element 20, they are sprayed with at least one thermally hardening binder by means of nozzles 23.

A laminating station 24 arranged above the conveying device consists of a supply roll 25 and several laminating rollers 26, wherein the supply roll 25 features a formed lamination fabric that is applied onto the fiber strip 22 by means of the laminating rollers 26.

The fiber strip 22 is usually narrower than the conveying element 20 and the formed lamination fabric 27 such that the formed lamination fabric 27 protrudes over the lateral surfaces of the fiber strip 22 that extend in the longitudinal direction and preferably lies on the conveying element 20 situated thereunder.

A compression device 28 arranged downstream of the conveying device 16 consists of two dies 29 that respectively feature a female mould 30, wherein the conveying element 20 with the mineral fibers arranged thereon and the formed lamination fabric 27 are compressed between the dies 29 of the compression device 28 and compressed into a strip 31 consisting of several moulded parts. A cutting device 32 with at least one knife 33 is arranged downstream of the compression device. The adjacently arranged moulded parts 1 of the strip 31 are at least partially separated from one another in the cutting device 32.

Contrary to the embodiment illustrated in FIG. 4, the cutting device 32 may also feature additional knives that cut parallel to the longitudinal direction of the strip 31.

The rollers 19 and the laminating rollers 26 consist of so-called spiked rollers, the outside of which features radially extending spikes 34 that penetrate into the formed lamination fabric 27 and the conveying element 20 to both sides of the fiber strip 22 and thusly serve for positively transporting the conveying element 20 and the formed lamination fabric 27, respectively.

In addition, the female moulds 30 of the dies 29 may be heated such that the dies 29 not only serve form shaping and compressing the moulded part, but also for activating and hardening the binder in the fiber strip 22.

The compression device 28 may also be realized in the form of a hardening furnace, in which hot air is blown into the conveying element 20, the fiber strip 22 and the formed lamination fabric 27.

### LIST OF REFERENCE SYMBOLS

1 Moulded part
2 Carrier material
3 Moulded body
4 Pressing device
5 Lower die
6 Mould
7 Upper die
8 Mould
9 Heating element
10 Reservoir
11 Reservoir
12 Nozzles
13 Supply line
14 Slide
15 Valve
16 Reservoir
17 Outlet
18 Conveying device
19 Roller
20 Conveying element
21 Supply roll
22 Fiber strip
23 Nozzle
24 Laminating station
25 Supply roll
26 Laminating roller
27 Formed lamination fabric
28 Compression device
29 Die
30 Female mould
31 Strip
32 Cutting device
33 Knife
34 Spike

1. A method for producing a moulded part that is preferably realized in the form of a heat and/or sound insulating element, particularly a compression-moulded part of mineral fibers such as, for example, rock wool and/or glass fibers, wherein the mineral fibers are agglomerated in the form of flocks and/or granulates, filled into a mould with or without binders and with predetermined bulk density and/or predetermined mass per unit area and/or predetermined binder proportion and subsequently compressed into a moulded part, particularly a compression-moulded part.

2. A method for producing a moulded part that is preferably realized in the form of a heat and/or sound insulating element, particularly a compression-moulded part of mineral fibers such as, for example, rock wool and/or glass fibers, preferably in the form of flocks and/or granulates, wherein the mineral fibers are deposited on a conveying element that becomes a component of the moulded part, and wherein a section of the conveying element with mineral fibers arranged thereon is cut off, particularly during or after the compression process.

3. The method according to claim 2,
characterized in
that the mineral fibers are connected to the conveying element, for example, by means of at least one binder.

4. The method according to claim 2,
characterized in
that the mineral fibers are deposited on the conveying element in an agglomerated fashion as flocks and/or granulates.

5. The method according to claim 2,
characterized in
that the mineral fibers are wetted with a binding and/or impregnating agent before they are deposited on the conveying element.

6. The method according to claim 2,
characterized in
that the conveying element consists of a formed carbon fiber fabric.

7. (canceled)

8. The method according to claim 2,
characterized in
that the conveying element is unwound from a supply device, particularly a supply roll, continuously or in a cycle that is defined, in particular, by a compression device that is realized, in particular, in the form of a pressing device.

9. (canceled)

10. The method according to claim 3 or 5,
characterized in
that inorganic binders and/or organic binders, particularly of renewable raw materials such as, for example, starch and/or glucose, are used as binders.

11. The method according to claim 2,
characterized in
that a lamination is arranged on the mineral fibers placed onto the conveying element.

12-16. (canceled)

17. The method according to claim 1,
characterized in
that the binder is added to the flocks and/or granulates before they are filled into the mould.

18. The method according to claim 1,
characterized in
that the binder is added to the flocks and/or granulates while and/or after they are filled into the mould.

19. The method according to claim 1 or 2,
characterized in
that the flocks and/or granulates are processed with a maximum size that passes through a mesh up to 100 mm, particularly up to 35 mm.

20. The method according to claim 1 or 2,
characterized in
that the flocks and/or granulates are filled into the mould with a bulk density of 20 to 1000 kg/m³, particularly 20 to 600 kg/m³, preferably 50 to 300 kg/m³.

21. (canceled)

22. The method according to claim 1,
characterized in
that inorganic binders and/or organic binders, particularly of renewable raw materials such as, for example, starch and/or glucose, are used as binders.

23. The method according to claim 1,
characterized in
that the flocks and/or granulates are agglomerated into larger elements, particularly into flock and/or granulate strips, or into moulded parts that preferably are highly compressed such as filler cushions, strips, webs, profiles or the like, before they are filled into the mould.

24-25. (canceled)

26. The method according to claim 1 or 2,
characterized in
that moulded parts with a mass per unit area between 200 and 7500 g/m², particularly between 500 and 5000 g/m², preferably between 500 and 4000 g/m², are produced from the flocks and/or granulates.

27. The method according to claim 1,
characterized in
that the flocks and/or granulates are stored in a reservoir, withdrawn from the reservoir in the required quantity and fed to at least one mould.

28-31. (canceled)

32. The method according to claim 1,
characterized in
that the flocks and/or granulates are deposited on a carrier material in the form of a moulded part after the admixing of the binder.

33. The method according to claim 1,
characterized in
that the mould is removed after the binder has hardened.

34. The method according to claim 1,
characterized in
that a moulded body is preformed in a blank mould, subsequently removed and transported to a compression process.

35. The method according to claim 1,
characterized in
that the flocks and/or granulates are hardened with the binder in the mould in order to form a moulded body consisting of the mould and the mineral fibers.

36. The method according to claim 1 or 2,
characterized in
that the flocks and/or granulates are bound mechanically, for example, by means of needling.

37-38. (canceled)

39. A device for producing a moulded part that is preferably realized in the form of a heat and/or sound insulating element, particularly a compression-moulded part of mineral fibers such as, for example, rock wool and/or glass fibers, with a reservoir, particularly a collection chamber for the mineral fibers, a conveying device arranged downstream of the reservoir and a compression device, in which the mineral fibers are compressed in a shaping fashion,
characterized in
that the conveying device (18) features a conveying element (20) that can be connected to the mineral fibers.

40-50. (canceled)

51. A moulded part in the form of a heat and/or a sound insulating element, particularly a lining part used in automobile construction, and consisting of mineral fibers that are agglomerated in the form of flocks and/or granulates, arranged in a mould and/or on a substrate with or without binders and with predetermined bulk density and/or predetermined mass per unit area and/or predetermined binder proportion and connected to one another under pressure, wherein the flocks and/or granulates are connected to the substrate or the mould.

52-62. (canceled)
